(19) United States
(12) Patent Application Publication
(10) Pub. No.: US 2006/0129588 A1
(43) Pub. Date: Jun. 15, 2006

(54) SYSTEM AND METHOD FOR ORGANIZING DATA WITH A WRITE-ONCE INDEX

(75) Inventors: Windsor Wee Sun Hsu, San Jose, CA (US); Shauchi Ong, San Jose, CA (US)

Correspondence Address: INTERNATIONAL BUSINESS MACHINES CORPORATION;INTELLECTUAL PROPERTY LAW, 650 HARRY ROAD, SAN JOSE, CA, 95120, US

(73) Assignee: INTERNATIONAL BUSINESS MACHINES CORPORATION, Armonk, NY (US)

(21) Appl. No.: 10/905,103

(22) Filed: Dec. 15, 2004

(51) Int. Cl. G06F 17/00

(52) U.S. Cl. 707/102

(57) ABSTRACT

According to the present invention, there is provided a system for organizing data objects for fast retrieval. The system includes at least one data storage medium defining data sectors. In addition, the system includes at least one data object on the data storage medium. Also, the system includes at least one key associated with the at least one data object. Moreover, the system includes at least one write-once index on the data storage medium to manage the at least one data object.

### FIELD OF THE INVENTION

The present invention relates generally to electronic data management, and, in particular, to indexing of electronic data.

### BACKGROUND OF THE INVENTION

As critical records (data objects) are increasingly stored in electronic form, it is imperative that they be stored reliably and in a tamper-proof manner. Furthermore, a growing subset of electronic records (e.g., electronic mail, instant messages, drug development logs, medical records, etc.) is subject to regulations governing their long-term retention and availability. Non-compliance with applicable regulations may incur severe penalty under some of the rules. The key requirement in many such regulations (e.g. SEC rule 17a-4) is that the records must be stored reliably in non-erasable, non-rewritable storage such that the records once written, cannot be altered or overwritten. Such storage is commonly referred to as WORM (Write-Once Read-Many) storage as opposed to rewritable or WMRM (Write-Many Read-Many) storage, which can be written many times.

With today's large volume of records, the records must further be indexed (e.g. by filename, by content, etc.) to enable the records that are relevant to an enquiry to be retrieved within the short response time that is increasingly expected. The index is typically stored in rewritable storage, but an index stored in rewritable storage can be altered to effectively delete or modify a record. For example, the index can be manipulated such that a given record cannot be located using the index.

There are existing methods to store the index in WORM storage. For example, the index (file directory) for traditional WORM storage (e.g., CD-R and DVD-R) is written at one go after a large collection of records has been indexed (e.g., when a CD-R is closed). Before the entire collection of records has been added, the index is not committed. Once the index is written, new records cannot be added to the index. As records are added over a period of time, the system would create many indexes, which uses a lot of storage space. More importantly, finding a particular record may require searching the records that have not been indexed as well as each of the indexes.

Other techniques include creating new updated copies of only the portions of the index that have changed. But if a portion of the index can be modified and rewritten after the index has supposedly been committed to WORM storage, then the index can effectively be modified to hide or alter records and the purpose of using WORM storage is defeated. Some might argue that the older versions of any updated portions of the index are still stored somewhere in the WORM storage but when the volume of records stored is huge and the retention period is long, as is commonly the case, verifying the many versions of an index is impractical.

What is needed is a way to organize large and growing collections of records for fast retrieval such that once a record has been inserted into an index, the index cannot be updated in such a way that the record can be effectively hidden or altered.

### SUMMARY OF THE INVENTION

According to the present invention, there is provided a system for organizing data objects for fast retrieval. The system includes at least one data storage medium defining data sectors. In addition, the system includes at least one data object on the data storage medium. Also, the system includes at least one key associated with the at least one data object. Moreover, the system includes at least one write-once index on the data storage medium to manage the at least one data object.

According to the present invention, there is provided a method for organizing data objects for fast retrieval. The method includes receiving a data object to be stored at at least one storage device. In addition, the method includes identifying at least one key associated with the received data object. In addition, the method includes identifying at least one write-once index at the storage device, wherein the write-once index is utilized to manage keys associated with data stored at the storage device. Also, the method includes determining if the key exists at the write-once index. Moreover, the method includes including the key at the write-once index if the key does not exist at the index.

### BRIEF DESCRIPTION OF THE DRAWINGS

FIG. 1 is a block diagram of a non-limiting storage device shown implemented as a disk drive

FIG. 2 is a flowchart of logic associated with a write-once index, according to an exemplary embodiment of the invention.

FIG. 3 is a flowchart of logic associated with adding a key to a write-once index, according to an exemplary embodiment of the invention.

FIG. 4 is a block diagram of an exemplary index according to the invention.

FIG. 5 is a flow chart of logic associated with probing an index for a key, according to an exemplary embodiment of the invention.

FIG. 6 is a flow chart of logic associated with adding a key to an index, according to an exemplary embodiment of the invention.

FIG. 7 is a diagram which shows the path for locating an object y through an index, according to an exemplary embodiment of the invention.

### DETAILED DESCRIPTION

The invention will be described primarily as a system and method for organizing data objects for fast retrieval. In the following description, for purposes of explanation, numerous specific details are set forth in order to provide a thorough understanding of the present invention. It will be evident, however, to one skilled in the art that the present invention may be practiced without these specific details.

Those skilled in the art will recognize that an apparatus, such as a data processing system, including a CPU, memory, I/O, program storage, a connecting bus and other appropriate components could be programmed or otherwise designed to facilitate the practice of the invention. Such a system would include appropriate program means for executing the operations of the invention.

An article of manufacture, such as a pre-recorded disk or other similar computer program product for use with a data processing system, could include a storage medium and program means recorded thereon for directing the data processing system to facilitate the practice of the method of the invention. Such apparatus and articles of manufacture also fall within the spirit and scope of the invention.

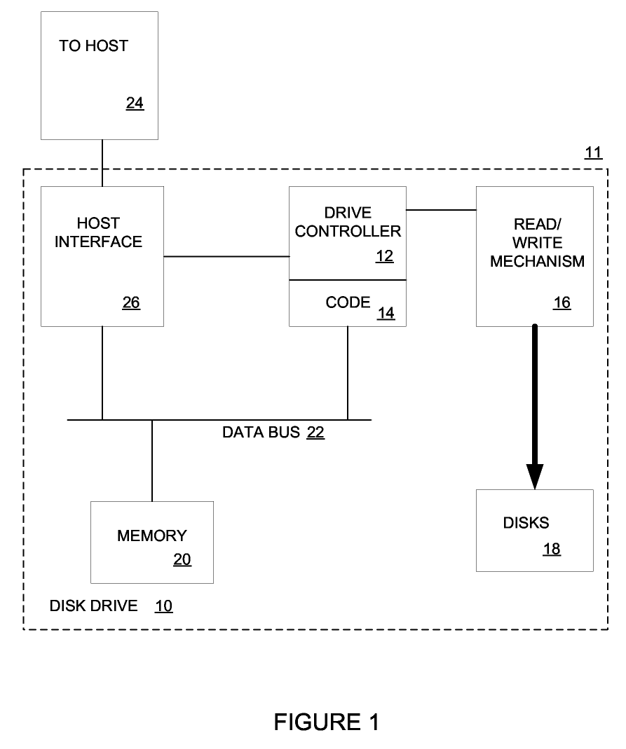

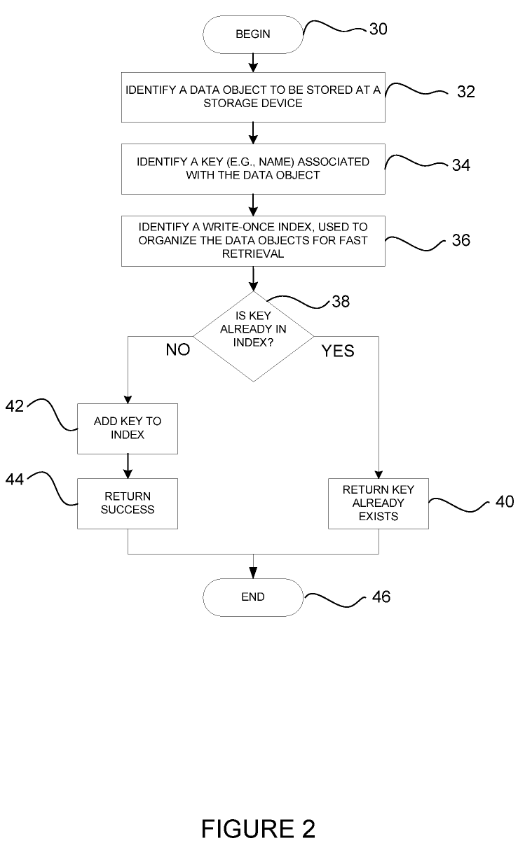

Referring initially to FIG. 1, an illustrative non-limiting data storage device is shown implemented as a disk drive 10. The non-limiting drive 10 shown in FIG. 2 has a housing 11 holding a disk drive controller 12 that can include and/or be implanted by a microcontroller. The controller 12 may access electronic data storage in a computer program device or product such as but not limited to a microcode storage 14 that may be implemented by a solid state memory device. The microcode storage 14 can store microcode embodying logic.

The controller 12 controls a read/write mechanism 16 that includes one or more heads for writing data onto one or more disks 18. Non-limiting implementations of the drive 10 include plural heads and plural disks 18, and each head is associated with a respective read element for, among other things, reading data on the disks 18 and a respective write element for writing data onto the disks 18. The disk 18 may include plural data sectors. More generally, as used below, the term “sector” refers to a unit of data that is written to the storage device, which may be a fixed size. The storage device can allow random access to any sector.

If desired, the controller 12 may also communicate with one or more solid state memories 20 such as a Dynamic Random Access Memory (DRAM) device or a flash memory device over an internal bus 22. The controller 12 can also communicate with an external host computer 24 through a host interface module 26 in accordance with principles known in the art.

FIG. 2 is a flowchart 28 of logic associated with a write-once index, according to an exemplary embodiment of the invention. At block 30, method 28 begins.

At block 32, a data object (e.g. file, object, database record) to be stored at a data storage device 10 is identified.

At block 34, a key (e.g., name) associated with the data object is identified. For the purpose of clearly describing the invention, we assume that each data object stored at the storage device 10 will be indexed. We further assume that each indexed data object has an entry in an index, and that the index entry contains a key identifying the data object and a pointer to the data object.

At block 36, a write-once index at storage device 10, to organize the data objects for fast retrieval, is identified.

At block 38, the write-once index is probed to determine whether the key already exists in the index. If so, an indication that the key already exists in the index is returned at block 40. Otherwise, the key is added to the index at block 42 and success is returned at block 44.

At block 46, method 28 ends.

The write-one index (block 36) is scalable from small collections of data objects (e.g. containing thousands of objects) to extremely large collections of data objects (e.g. containing billions of objects and beyond). The maximum or preferred maximum size of the collection of objects to be indexed does not have to be specified in advance. The index simply grows to accommodate additional objects.

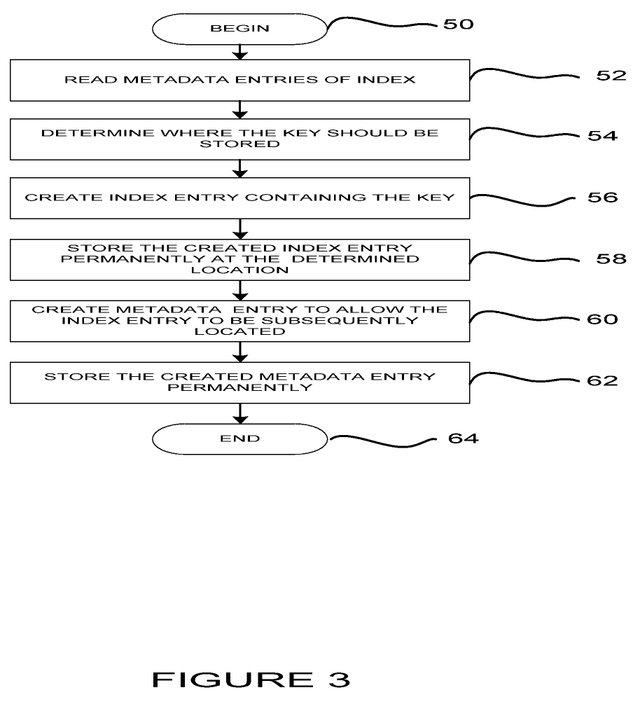

FIG. 3 is a flow chart of logic associated with adding a key to such an index, according to an exemplary embodiment of the invention. At block 50, method 48 begins.

At block 52, the metadata entries of the index is read and used at block 54 to determine where the key to be added should be stored.

At block 56, an index entry is created for the key to be added.

At block 58, the created index entry is permanently stored at the location determined at block 54. The index entry is permanently stored in the sense that the contents of the index entry is not updated, and the index entry is not relocated to another storage location, for at least the life time of the corresponding data object.

At block 60, a metadata entry is created to allow the created index entry to be subsequently located.

At block 62, the created metadata entry is permanently stored in the sense that the contents of the created metadata entry is not updated, and the metadata entry is not relocated to another storage location, for at least the life time of the corresponding index entry.

At block 64, method 48 ends.

By creating the index and metadata entries such that their contents and storage locations are fixed, as described above, the set of possible storage locations at which an index entry containing a given key can be found is fixed after the key is inserted into the index. The index cannot be updated in such a way that an object in the index can be hidden or effectively altered.

To look up a key in the index, the metadata entries are first read to determine the possible storage locations of an index entry containing the identified key. Next, the possible storage locations are searched to find an index entry containing the key. If no such index entry is found, a message, indicating that the key does not exist in the index, is returned. Otherwise, success is returned.

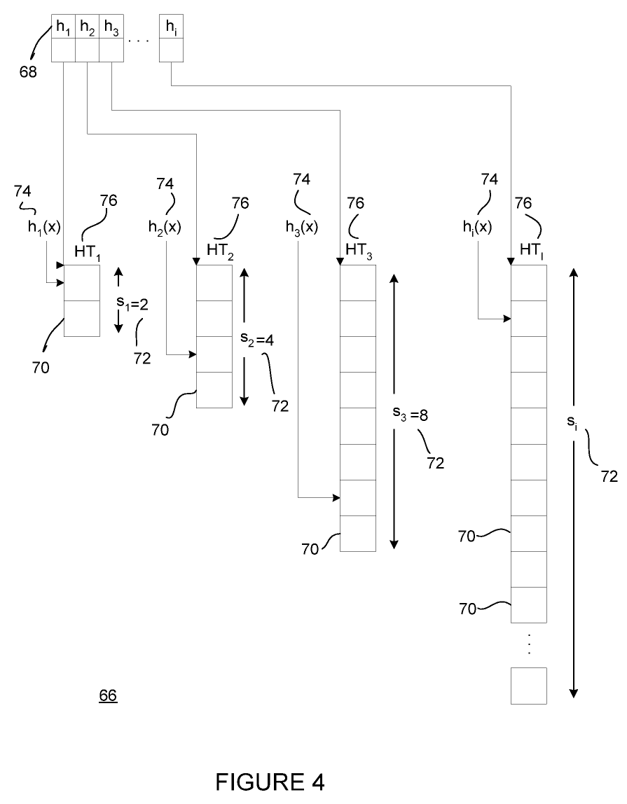

FIG. 4 is a block diagram of an exemplary embodiment of a write-once index 66 according to the invention. There are i hash tables (HT) 76, each of size sᵢ 72 and each indexed by a hash function hᵢ 74. Keys are stored at the hash tables 76. Metadata 68 records the hash function used at each hash table and the location where each of the hash tables is stored.

In one embodiment, the series of hash tables are generally increasing in size, meaning that, for the most part, s_{i>=}sᵢ₋₁. In a preferred embodiment, the size of the hash tables increases largely exponentially such that, for most values of i, sᵢ is approximately equal to k×sᵢ₋₁ for some constant k>1. In yet another embodiment, the hᵢ's 74 are fairly independent meaning that if hⱼ(x)=hⱼ(y), it is unlikely that hᵢ(x)=hᵢ(y), for j≠l and x≠y.

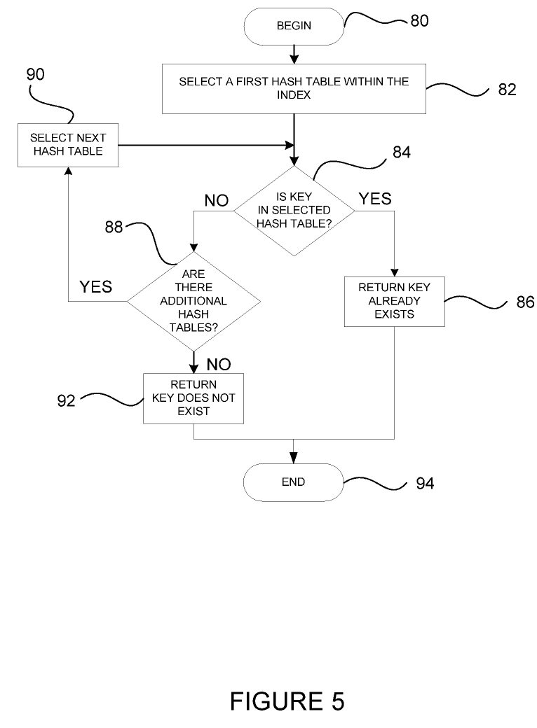

FIG. 5 is a flow chart of logic associated with looking up a key in index 66, according to an exemplary embodiment of the invention. At block 80, method 78 begins.

At block 82, a first hash table 76 within the index 66 is selected.

At block 84, a determination is made as to whether the identified key exists within the selected hash table 76. Each hash table 76 is made up of multiple hash buckets 70. For example, to determine whether a key, k, exists within the j-th hash table, HTⱼ, hⱼ(k) is computed and a determination is made as to whether k exists in the hⱼ(k)-th hash bucket of HTⱼ.

At block 84, if it is determined that the key is in the selected hash table 76, then a message, indicating that the key exists in the index, is returned.

At block 84, if it is determined that the key is not in the selected hash table 76, a determination is made at block 88 as to whether there are additional hash tables 76. If yes, then at block 90 a next hash table 76 is identified and selected. The process is repeated until the last hash table 76 is reached.

Returning to block 88, if a determination is made that there are no additional hash tables 76, then the key does not exist in the index 66 and a message, indicating that the key does not exist in the index, is returned at block 92.

At block 94, method 78 ends.

In one embodiment, the first hash table in the series of hash tables, i.e. HTₒ, is selected at block 82 and a next hash table in the series of hash tables is selected at block 90. In another embodiment, the last hash table in the series of hash tables, i.e. HTᵢ, is selected at block 82 and a preceding hash table in the series of hash tables is selected at block 90.

In yet another embodiment, a determination is made at block 88 as to whether there is sufficient room in the selected hash table to store the identified key. If it is determined that there is sufficient room, then the key does not exist in the index 66 and a message, indicating that the key does not exist in the index, is returned at block 92. If it is determined that there is not sufficient room, then the determination is made as to whether there are additional hash tables 76.

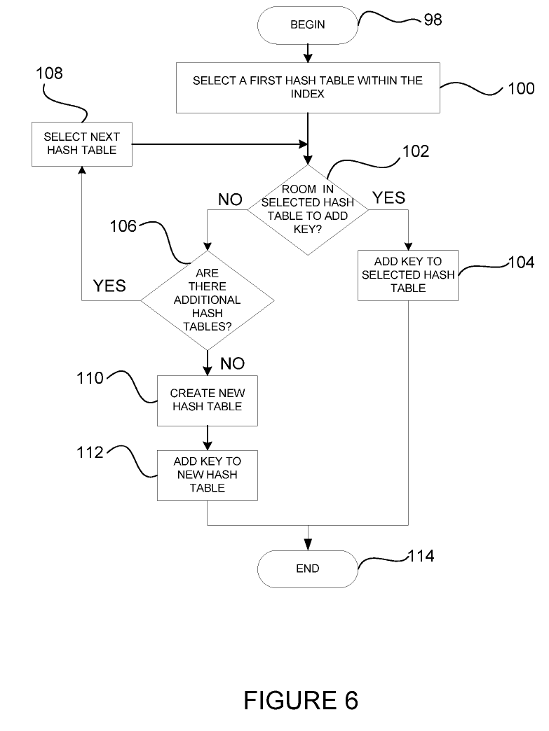

FIG. 6 is a flow chart of logic associated with adding a key to index 66, according to an exemplary embodiment of the invention. At block 98, method 96 begins.

At block 100, a first hash table 76 within the index 66 is selected.

At block 102, a determination is made as to whether there is enough room in the selected hash table 76 to add the identified key. For example, to determine whether there is enough room in the j-th hash table, HTⱼ, to add a key, k, hⱼ(k) is computed and a determination is made as to whether there is enough room in the hⱼ(k)-th hash bucket of HTⱼ to contain k.

At block 104, if there is enough room in the selected hash table to add the key, the key is added.

If there is not enough room in the selected hash table to add the key, a determination is made at block 106 as to whether there are additional hash tables 76. If yes, then at block 108 a next hash table 76 is identified and selected. The process is repeated until the last hash table 76 is reached.

Returning to block 106, if a determination is made that there are no additional hash tables 76, then a new hash table, HTᵢ₊₁, is created at block 110, and the key is added to the new hash table at block 112. For example, to add a key, k, to the j-th hash table, HTⱼ, hⱼ(k) is computed and k is inserted into the hⱼ(k)-th hash bucket of HTⱼ. Creating a new hash table includes adding new information to the metadata 68 of the index 66.

At block 114, method 96 ends.

The write-once index 66 automatically scales by adding hash tables as necessary for the number of objects stored. When the system creates a hash table, it is preferred that the hash table be approximately a constant multiple larger than the last created table. This ensures that the complexity of the look up and insert operations is logarithmic in the number of objects in the index.

In one embodiment, the index 66 is stored at a different storage device than the data objects. In another embodiment, the index 66 is stored at a WORM storage device to ensure that no portion of the index can be altered once the portion has been stored. In a preferred embodiment, both the index 66 and the data objects are stored at a WORM storage device.

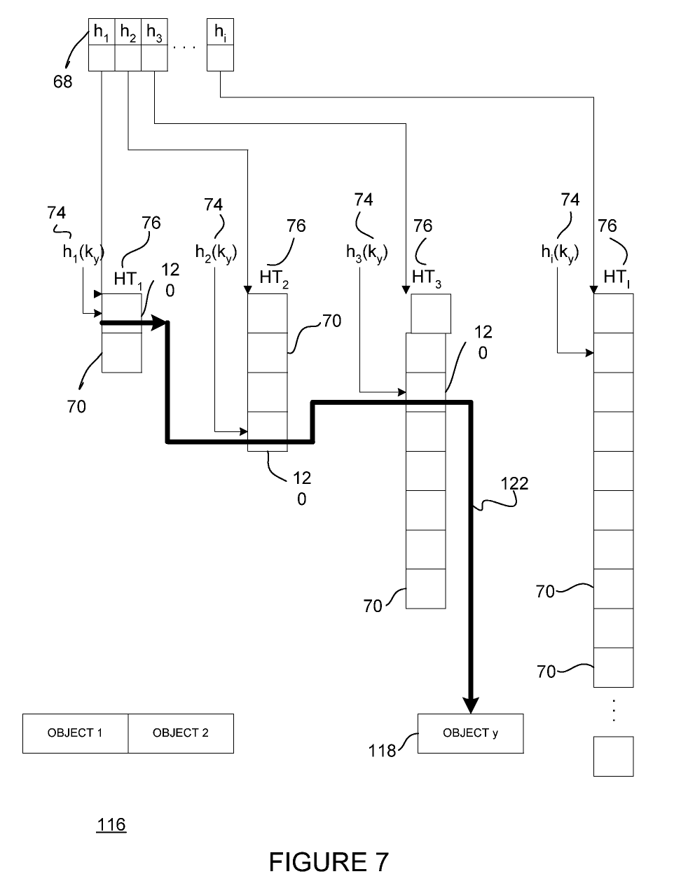

Note that the invention provides that the path through the index to locate a data object is immutable once the data object has been indexed. For example, FIG. 7 is a diagram 116 which shows the path 122 for an object y 118. The hash buckets 120 that are examined along the path are determined by a key, k_{y}, associated with the requested data object and the hash functions at the various levels. The hash function for a hash table is fixed at the time the table is created. Therefore, the same hash buckets are always examined to get to that object. The index entry associated with the stored data is also immutable once the entry has been written. This ensures that the path through the index to locate an object is unalterable once the object has been indexed. In other words, the index cannot be updated in such a way that an object in the index can be hidden or effectively altered.

Hash Functions

In a preferred embodiment, the hash functions, h₁, h₂, . . . , hᵢ, 74 are largely independent, so that if some of the keys are clustered at one level, they will be dispersed at the next level. There are multiple ways to pick such hash functions 74. In one preferred embodiment, universal hashing is utilized.

Universal hashing involves choosing a hash function 74 at random from a carefully designed class of functions. For example, let φ be a finite collection of hash functions that map a given universe U of keys into the range {0, 1, 2, . . . ,m−1}. φ is called universal if for each pair of distinct keys x, y ∈ U, the number of hash functions h for which h(x)=h(y) is precisely equal to |φ∥m. With a function randomly chosen from φ, the chance of a collision between x and y (i.e., h(x)=h(y)) where x≠y is exactly 1|m.

For example, let m be a prime number larger than 255. Suppose we decompose the key x into r bytes such that x=(x₁, x₂, . . . , xᵣ). Let a=(a₁, a₂, . . . , aᵣ) denote a sequence of r elements chosen randomly from the set {0, 1, . . . ,m−1}. The collection of hash functions h^{a}(x)=Σ^{r}ₖ₌₁ aₖxₖ mod m forms a universal set of hash functions.

When the system creates a new hash table of size sⱼ>255 at level j, it selects the hash function hᵢ randomly from the set {h^{a}(x)=Σ^{r}ₖ₌₁ aₖxₖ mod sⱼ} by picking a₁, a₂, . . . , aᵣ at random from the set {0, 1, . . . , sⱼ}. The aₖ's are permanently associated with that hash table and are stored as part of the metadata 68 of the index 66. In a preferred embodiment, the metadata is stored in WORM storage so that the metadata cannot be altered.

Hash Table Optimizations

There are many known optimizations such as open addressing, double hashing, etc. for hash tables. In the invention, the hash table at each level can be separately optimized by using one or more of these methods. In a preferred embodiment, the hash table at each level uses linear addressing so that a key can be found in the hashed bucket or any of a predetermined number of following buckets. When the hash table is probed, the hashed bucket and the predetermined number of following buckets are read sequentially from the storage system. This takes advantage of the fact that sequential I/O tends to be dramatically more efficient than random I/O. In another embodiment, each hash table is double-hashed. The two hash functions are each chosen randomly form a universal set of hash functions.

Duplicate Keys

Note that in the description thus far, it is assumed that duplicate keys are not allowed in the index. It should be apparent, that in an alternative embodiment, duplicate keys are allowed. In the alternative embodiment, when inserting a key into the index, no determination is made as to whether the key already exists. Instead, space to insert the key is located, and the key is inserted. In order to find all possible occurrences of a key, the system probes all the hash tables looking for the key. In another embodiment, the system probes the series of hash tables until a hash table is reached that has enough space for that key to be inserted.

Deletion of a Key

In the preferred embodiment, deletion of a key from the index is not allowed. However, in an alternative embodiment, objects can be deleted after a predetermined period of time, and the corresponding keys can be removed from the index after the objects have been removed.

In one embodiment, the index is stored in storage that guarantees data immutability until a predetermined expiration time (date), which is typically specified when the data was written. In such a system, the expiration date for a unit of storage (e.g. sector, block, object, file) containing index entries is set to the latest of the expiration dates of the corresponding objects.

After an object has been deleted, the system checks the index to see if the corresponding key is stored in a unit of storage that contains at least one key of a life object. If so, the key corresponding to the deleted object cannot be removed for now. Otherwise, the system deletes all the keys in the storage unit by, for example, overwriting it with a standard pattern.

An optimization for such a system is to avoid adding a key to a storage unit containing keys of objects with vastly different remaining life. For instance, the system might add a key to a given storage unit only if the corresponding object has a remaining life that is within a month of that of the other objects with keys in that storage unit. In other words, the index entry for an object is stored at a location that is determined by the key of the object and the expiration date of the object.

Note that depending on the underlying storage, a storage unit may be reusable after its expiration data. If a storage unit containing a deleted portion of a hash table can be reused, the system would not be able to use the optimizations mentioned above. For example, it would not be able to conclude that a key, k, does not exist in the index once the system reaches a hash table that does not contain k and yet has enough space for containing k. The system would have to check all the hash tables.

It should be apparent that the invention disclosed herein can be applied to organize all kinds of objects for fast retrieval by various keys. Examples include the file system directory which allows files to be located by the file name, the database index which enables records to be retrieved based on the value of some specified field or combination of fields, and the full-text index which allows documents containing some particular words or phrases to be found.

Thus, a system and method for organizing data objects for fast retrieval has been disclosed. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A system for organizing data objects for fast retrieval, including:
at least one data storage medium defining data sectors;
at least one data object on the data storage medium;
at least one key associated with the at least one data object; and
at least one write-once index on the data storage medium to manage the at least one data object.

2. The system of claim 1 wherein the data storage medium on which the write-once index is stored is a WORM storage medium.

3. The system of claim 1 wherein the index includes at least one hash table, wherein the at least one hash table is utilized to store the at least one key.

4. The system of claim 3 wherein the at least one hash table includes a series of hash tables, the series of hash tables being generally increasing in size.

5. The system of claim 4 wherein the series of hash tables have sizes that are increasing largely in an exponential manner.

6. The system of claim 3 wherein the storing of the key at the at least one hash table includes:
determining if there is enough room at a first hash table, and storing the key at the first hash table if there is,
otherwise storing the key at a second hash table, and if there is no second hash table, creating a new hash table and storing the key there.

7. The system of claim 4 wherein the storing of the key at the at least one hash table includes:
determining if there is enough room at the first hash table in the series, and storing the key at the hash table if there is,
otherwise storing the key at the next hash table in the series, and if there is no next hash table in the series, creating a new hash table as the next hash table in the series and storing the key there.

8. The system of claim 3 wherein retrieving a data object includes probing a first hash table to determine if a key of the data object exists at the first hash table, and if it does not, probing a second hash table to determine if a key of the data object exists at the second hash table, and if there is no second hash table, returning an indication that the data object does not exist at the system.

9. The system of claim 8 wherein probing a hash table to determine if a key of the data object exists at the hash table further includes determining if there is enough room at the hash table for storing the key, and returning an indication that the data object does not exist at the system if a key of the data object does not exist at a hash table and there is enough room at the hash table for storing the key.

10. The system of claim 4 wherein retrieving a data object includes probing the first hash table in the series to determine if a key of the data object exists at the first hash table in the series, and if it does not, probing a next hash table in the series to determine if a key of the data object exists at the next hash table in the series, and if there is no next hash table in the series, returning an indication that the data object does not exist at the system.

11. The system of claim 10 wherein probing a hash table to determine if a key of the data object exists at the hash table further includes determining if there is enough room at the hash table for storing the key, and returning an indication that the data object does not exist at the system if a key of the data object does not exist at a hash table and there is enough room in the hash table for storing the key.

12. The system of claim 4 wherein retrieving a data object includes probing the last hash table in the series to determine if a key of the data object exists at the last hash table in the series, and if it does not, probing a preceding hash table in the series to determine if a key of the data object exists at the preceding hash table in the series, and if there is no preceding hash table in the series, returning an indication that the data object does not exist at the system.

13. The system of claim 3, wherein the write-once index is scalable from small collections of data objects to extremely large collections of data objects and wherein the write-once index includes index entries containing fixed content and having permanent storage locations.

14. The system of claim 13, wherein the write-once index further includes metadata entries containing fixed content and having permanent storage locations, such metadata entries being used for locating the index entries.

15. The system of claim 13, wherein the possible storage locations at which an index entry containing a given key can be found at the index is fixed after the key has been stored at the index.

16. The system of claim 13, wherein the possible locations for storing an index entry depends on the expiration date of the corresponding data object.

17. A method of organizing data objects for fast retrieval, including:
receiving a data object to be stored at at least one storage device;
identifying at least one key associated with the received data object;
identifying at least one write-once index at the storage device, wherein the write-once index is utilized to manage keys associated with data objects stored at the storage device;
determining if the key exists at the write-once index; and
including the key at the write-once index if the key does not exist at the index.

18. The method of claim 17 wherein the storage device at which the write-once index is stored is a WORM storage device.

19. The method of claim 17 wherein the index includes at least one hash table, wherein the at least one hash table is utilized to store the at least one key.

20. The method of claim 19 wherein the at least one hash table includes a series of hash tables, the series of hash tables being generally increasing in size.

21. The method of claim 20 wherein the series of hash tables have sizes that are increasing largely in an exponential manner.

22. The method of claim 19 wherein the storing of the key at the at least one hash table includes
determining if there is enough room at a first hash table, and storing the key at the first hash table if there is,
otherwise storing the key at a second hash table, and if there is no second hash table, creating a new hash table and storing the key there.

23. The method of claim 20 wherein the storing of the key at the at least one hash table includes
determining if there is enough room at the first hash table in the series, and storing the key at the hash table if there is,
otherwise storing the key at the next hash table in the series, and if there is no next hash table in the series, creating a new hash table as the next hash table in the series and storing the key there.

24. The method of claim 19 wherein retrieving a data object includes probing a first hash table to determine if a key of the data object exists at the first hash table, and if it does not, probing a second hash table to determine if a key of the data object exists at the second hash table, and if there is no second hash table, returning an indication that the data object does not exist at the system.

25. The method of claim 24 wherein probing a hash table to determine if a key of the data object exists at the hash table further includes determining if there is enough room at the hash table for storing the key, and returning an indication that the data object does not exist at the system if a key of the data object does not exist at a hash table and there is enough room at the hash table for storing the key.

26. The method of claim 20 wherein retrieving a data object includes probing the first hash table in the series to determine if a key of the data object exists at the first hash table in the series, and if it does not, probing a next hash table in the series to determine if a key of the data object exists at the next hash table in the series, and if there is no next hash table in the series, returning an indication that the data object does not exist at the system.

27. The method of claim 26 wherein probing a hash table to determine if a key of the data object exists at the hash table further includes determining if there is enough room at the hash table for storing the key, and returning an indication that the data object does not exist at the system if a key of the data object does not exist at a hash table and there is enough room in the hash table for storing the key.

28. The method of claim 20 wherein retrieving a data object includes probing the last hash table in the series to determine if a key of the data object exists at the last hash table in the series, and if it does not, probing a preceding hash table in the series to determine if a key of the data object exists at the preceding hash table in the series, and if there is no preceding hash table in the series, returning an indication that the data object does not exist at the system.

29. The method of claim 19, wherein the write-once index is scalable from small collections of data objects to extremely large collections of data objects and wherein including the key at the write-once index includes creating an index entry containing fixed content and storing the index entry at a permanent storage location.

30. The method of claim 29, wherein including the key at the write-once index further includes creating a metadata entry containing fixed content and storing the metadata entry at a permanent storage location, such a metadata entry being used for locating the index entry.

31. The method of claim 29, wherein including the key at the write-once index permanently establishes the possible storage locations at which an index entry containing the key can be found.

32. The method of claim 29, wherein storing the index entry at a permanent storage location includes storing the index entry at a permanent storage location determined by the expiration date of the corresponding data object.
